(19) United States
(12) Patent Application Publication
(10) Pub. No.: US 2024/0062545 A1
(43) Pub. Date: Feb. 22, 2024

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Yu NABETO, Tokyo (JP); Haruna Watanabe, Tokyo (JP); Soma Shiraishi, Tokyo (JP)

(73) Assignee: NEC Corporation, Minato-ku, Tokyo (JP)

(21) Appl. No.: 18/270,557

(22) PCT Filed: Jan. 6, 2021
(86) PCT No.: PCT/JP2021/000215

§ 371 Date: Jun. 30, 2023

(51) Int. Cl. G06V 20/40

(52) U.S. Cl. CPC G06V 20/44; G06V 20/49

(57) ABSTRACT

In an information processing device, an acquisition means acquires a video material. An important scene detection means detects an important scene in the video material. An event segment detection means detects an event segment in the video material by using a detection result of the important scene.

### TECHNICAL FIELD

The present disclosure relates to processing of video data.

### BACKGROUND ART

Techniques for generating a video digest from video images have been proposed. Patent Document 1 discloses a highlight extraction device in which a learning data file is created from video images for training prepared in advance and video images for an important scene specified by a user, and the important scene is detected from target video images based on the learning data file.

### PRECEDING TECHNICAL REFERENCES

### Patent Document

Patent Document 1: Japanese Laid-open Patent Publication No. 2008-022103

### SUMMARY

### Problem to be Solved by the Invention

In a case where an important scene is extracted from a video material to create a digest video, a process is performed to detect the important scene from the entire video material. However, since the video material usually takes a long time, a process for detecting the important scene and the like takes time. Moreover, even in a case where a processing time is not a major issue, when a detection accuracy of an important scene or the like is not sufficiently high, an inappropriate scene may be included in the digest video.

It is one object of the present disclosure to provide an information processing device capable of efficiently extracting a part of an event in the video material and creating the digest video with high accuracy.

### Means for Solving the Problem

According to an example aspect of the present disclosure, there is provided an information processing device including:
an acquisition means configured to acquire a video material;
an important scene detection means configured to detect an important scene in the video material; and
an event segment detection means configured to detect an event segment in the video material by using a detection result of the important scene.

According to another example aspect of the present disclosure, there is provided an information processing method including:
acquiring a video material;
detecting an important scene in the video material; and
detecting an event segment in the video material by using a detection result of the important scene.

According to a further example aspect of the present disclosure, there is provided a recording medium storing a program, the program causing a computer to perform a process including:
acquiring a video material;
detecting an important scene in the video material; and
detecting an event segment in the video material by using a detection result of the important scene.

### Effect of the Invention

According to the present disclosure, it becomes possible to efficiently extract a part of an event in a video material and to create a digest video with high accuracy.

### BRIEF DESCRIPTION OF THE DRAWINGS

FIG. 1 illustrates a basic concept of a digest generation device.

FIG. 2A and FIG. 2B illustrate examples of a digest video and an event segment.

FIG. 3A and FIG. 3B illustrate configurations at training and at an inference of an importance scene detection model.

FIG. 4A and FIG. 4B are diagrams for explaining a generation method of training data of an event segment detection model.

FIG. 5 is a block diagram illustrating a functional configuration of a training device of the event segment detection model.

FIG. 6 a block diagram illustrating a hardware configuration of a digest generation device.

FIG. 7 schematically illustrates a detection method of the event segment by a digest generation device of a first example embodiment.

FIG. 8 is a block diagram illustrating a functional configuration of the digest generation device of the first example embodiment.

FIG. 9 is a flowchart of a digest generation process by the digest generation device of the first example embodiment.

FIG. 10 schematically illustrates a detection method of the event segment by a digest generation device of a second example embodiment.

FIG. 11 is a block diagram illustrating a functional configuration of the digest generation device of the second example embodiment.

FIG. 12 is a flowchart of a digest generation process executed by the digest generation device of the second example embodiment.

FIG. 13 is a block diagram illustrating a functional configuration of an information processing device of a third example embodiment.

FIG. 14 is a flowchart of a process by the information processing device of the third example embodiment.

### EXAMPLE EMBODIMENTS

In the following, example embodiments will be described with reference to the accompanying drawings.

<Basic Concept of Digest Generation Device>

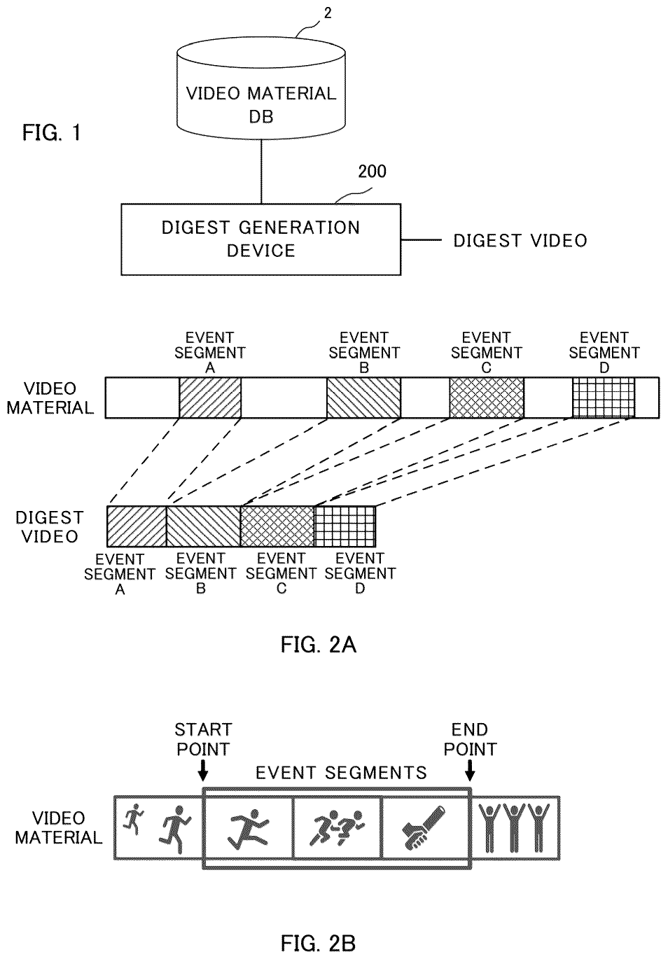

FIG. 1 illustrates a basic concept of a digest generation device. The digest generation device 100 is connected to a video material database (device, referred to as “DB”) 2. The video material DB 2 stores various video materials, that is, moving pictures. The video material may be, for instance, a video such as a television program broadcasted from a broadcasting station, or may be a video distributed by the Internet or the like. Note that the video material may or may not include audio. The digest generation device 200 generates and outputs the digest video which uses a part of the video material stored in the video material DB 2, The digest video is a video in which scenes where some kind of event occurred in the video material are connected in a time series. As will be described later, the digest generation device 200 detects each event segment from the video material using an event segment detection model which has been trained by machine learning, and generates the digest video by connecting the event segments in the time series. The event segment detection model is a model for detecting each segment of the event from the video material, for instance, a model using a neural network can be used.

FIG. 2A illustrates an example of the digest video. In the example in FIG. 2A, the digest generation device 200 extracts event segments A to D included in the video material, and connects the extracted event segments in the time series to generate the digest video. Note that the event segments extracted from the video material may be repeatedly used in the digest video depending on contents thereof.

FIG. 2B illustrates an example of the event segment. The event segment is formed by a plurality of frame images corresponding to the scene in which some kind of event occurred in the video material. The event segment is defined by a start point and an end point. Note that instead of the end point, the event segment may be defined using a length of the event segment,

<Basic Principle>

Next, the basic principle of the digest generation device according to the example embodiments will be described. When a digest video is created from a video material, the video material is input to an event segment detection model to detect each event segment. However, in general, since the video material is long, when a detection process of the event segment is performed for the entire video material, the process takes time. Even if a process time is not much of an issue, scenes other than the event may be included in the digest video when a detection accuracy of the event is not sufficiently high.

Therefore, in the present example embodiment, a digest video is created by using the event segment detection model and a model (hereinafter, referred to as an “important scene detection model”) which detects an important scene from the video material. Accordingly, the efficiency and accuracy in the creation of the digest video are improved.

<Important Scene Detection Model>

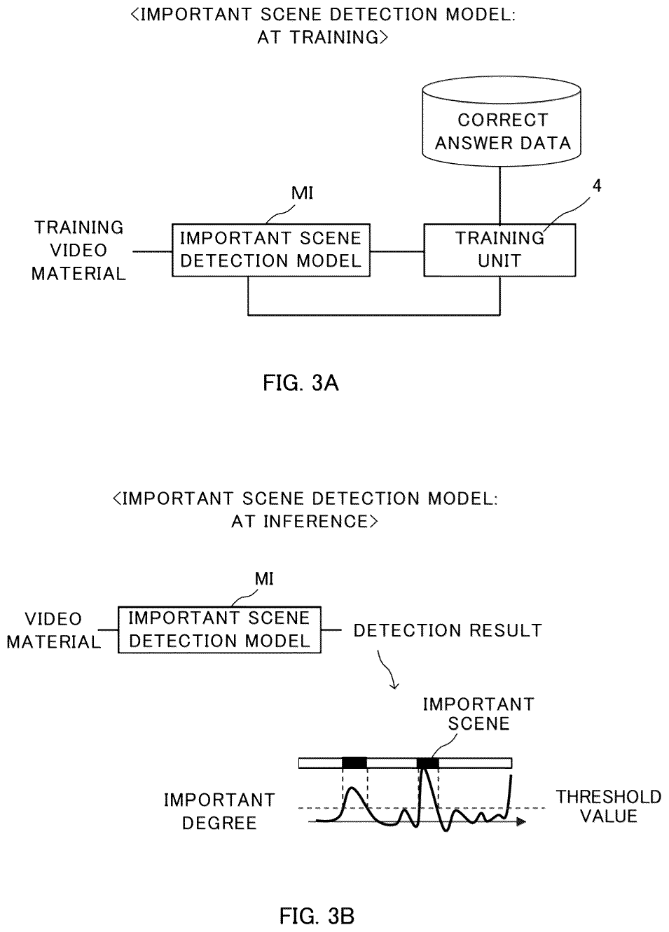

Next, the important scene detection model will be described. FIG. 3A illustrates a configuration for training the important scene detection model for use by the digest generation device 100. A training data set prepared in advance is used for training the important scene detection model. The training data set corresponds to a pair of the training video material and correct answer data indicating a correct answer with respect to the training video material. The correct answer data are data in which a tag (hereinafter, referred to as a “correct answer tag”) indicating the correct answer is added to a position of the important scene in the training video material. Typically, an assignment of the correct answer tag in the correct answer data is carried out by an experienced editor or the like. For instance, for the video material of a live baseball game, a baseball commentator or the like selects a highlight scene during a game, and assigns the correct answer tag. In addition, an assignment method for the correct answer tag by the editor may be learned by machine learning or the like, and the correct answer tag may be automatically assigned.

At the training, the training video material is input into an important scene detection model MI. The important scene detection model MI extracts each important scene from the video material. In detail, the important scene detection model MI extracts features from one frame or a plurality of frames forming the video material, and calculates a degree of importance (importance score) for the video material based on the extracted features. After that, the important scene detection model MI outputs a part in which the degree of importance is equal to or more than a predetermined threshold as the important scene. A training unit 4 optimizes the important scene detection model MI using an output of the important scene detection model MI and the correct answer data. In detail, the training unit 4 compares the important scene output from the important scene detection model MI with the scene indicated by the correct answer tag included in the correct answer data, and updates parameters of the important scene detection model MI so as to reduce an error (lost). The trained important scene detection model MI can extract, as the important scene from a video material, each scene which is close to the scene to which the correct answer tag is assigned by an editor.

FIG. 3B illustrates a configuration at an inference performed by the important scene detection model MI. At the inference, the video material is input into the trained important scene detection model MI. The important scene detection model MI calculates, as the important scene, the degree of importance based on the video material, and extracts a portion in which the degree of importance is equal to or more than a predetermined as the important scene.

<Event Segment Detection Model>

Next, the event segment detection model will be described.

(Generation Method of the Training Data)

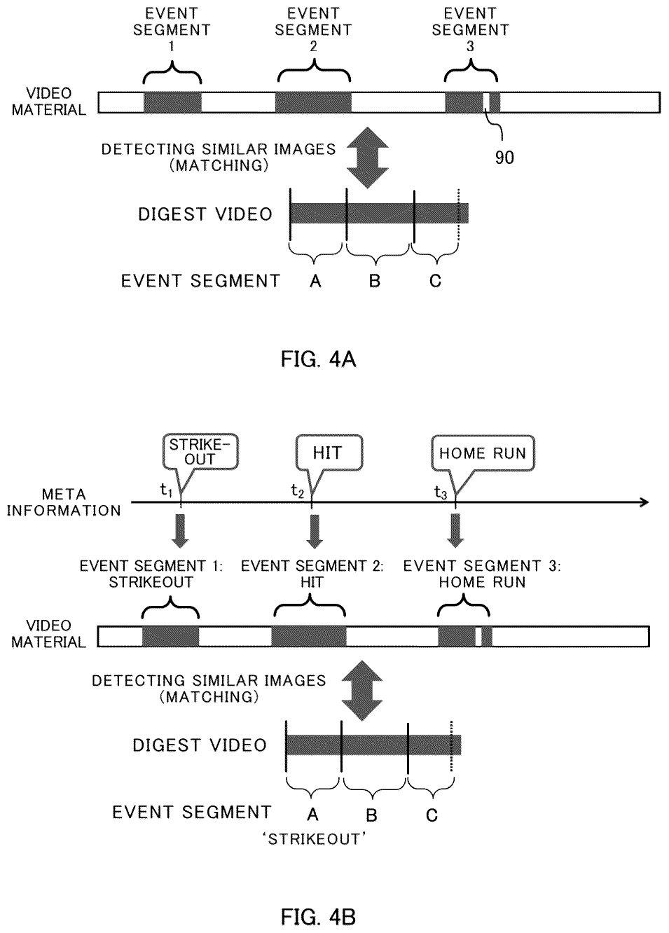

FIG. 4A is a diagram illustrating a generation method of the training data used for training the event segment detection model. First, an existing digest video is prepared. This digest video has already been created as containing appropriate content and includes a plurality of event segments A to C which are separated at appropriate points.

The training device of the event segment detection model performs matching between the video material and the digest video, detects each segment having a similar content as the event segment included in the digest video from the video material, and acquires time information of a start point and an end point of the event segment. Note that instead of the end point, a time range from the start point may be used. The time information indicates a timecode or a frame number in the video material. In the example in FIG. 4A, event segments 1 to 3 are detected in the video material corresponding to the event segments A to C in the digest video.

Note that even in a case where there is a segment with a slightly discrepant content between coincident segments where the video material and digest video are consistent in content, when a discrepant segment is less than a predetermined time range (that is, 1 second), the training device may consider the discrepant segment as one coincident segment together with a previous coincident segment and a subsequent coincident segment. In the example in FIG. 4A, in the event segment 3 of the video material, there is a disagreement segment 90 which does not match the event segment C in the digest video, but since a time range of the disagreement segment 90 is equal to or less than a predetermined value, the disagreement segment 90 is included in the event segment 3.

In a case where there is meta information which includes time and an event name (event class) of the event in the video material, the training device may use the meta information to assign tag information indicating the event name to each event segment. FIG. 4B illustrates an example of assigning tag information using the meta information. The meta information includes an event name “STRIKEOUT” of a time t₁, an event name “HIT” of a time t₂, and an event name “HOME RUN” of a time t₃. In this case, the training device assigns the tag information “STRIKEOUT” to the event segment 1 detected in the video material, the tag information “HIT” to the event segment 2, and the tag information “HOME RUN” to the event segment 3. The assigned tag information is used as a part of the correct answer data in the training data.

In the above-described example, the tag information is assigned to each event segment using the meta information including the event name, but instead, a human may assign the tag information to the digest video by visually inspecting each event forming the digest video. In this case, the training device may reflect the tag information assigned to the event segment of the digest video in the event segment of the video material corresponding to the event segment of the digest video based on a correspondence relationship obtained by matching the video material with the digest video. For instance, in the example in FIG. 4B, in a case where the tag information “STRIKEOUT” is assigned to the event segment A in the digest video, the training device may add the tag information “STRIKEOUT” to the event segment 1 corresponding to that event segment A in the video material.

(Configuration of the Training Device)

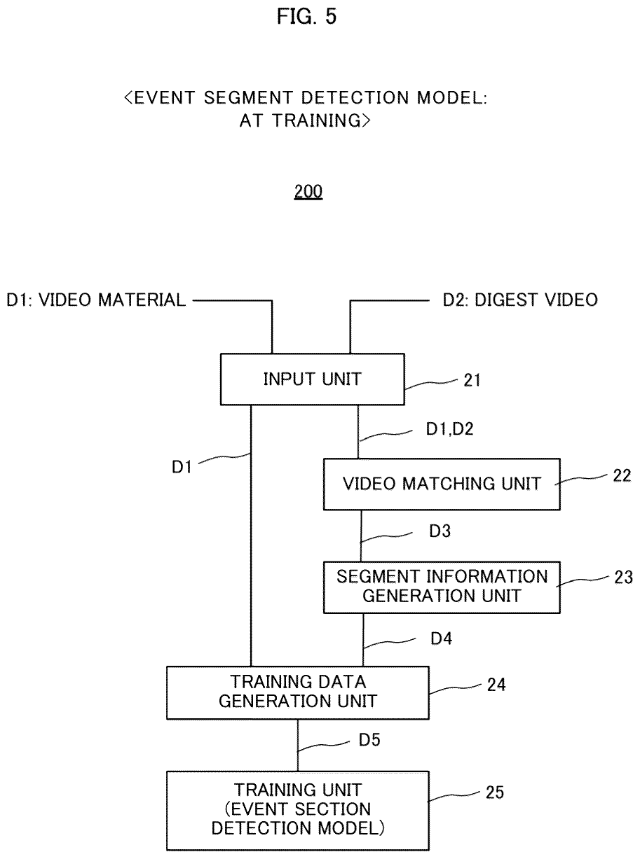

FIG. 5 is a block diagram illustrating a functional configuration of the training device 200 of the event segment detection model. The training device 200 includes an input unit 21, a video matching unit 22, a segment information generation unit 23, a training data generation unit 24, and a training unit 25.

A video material D1 and a digest video D2 are input to the input unit 21. The video material D1 corresponds to an original video of the training data. The input unit 21 outputs the video material D1 to the training data generation unit 24, and outputs the video material D1 and the digest video D2 to the video matching unit 22.

As illustrated in FIG. 4A, the video matching unit 22 performs the matching between the video material D1 and the digest video D2, generates coincident segment information D3 indicating a coincident segment in which the videos are matched in content, and outputs the coincident segment information D3 to the segment information generation unit 23.

The segment information generation unit 23 generates the segment information to be a series of scenes based on the matching segment information D3. In detail, in a case where a certain coincident segment is equal to or more than the predetermined time range, the segment information generation unit 23 determines that coincident segment as the event segment, and outputs segment information D4 of the event segment to the training data generation unit 24. Furthermore, in a case where a time range of the discrepancy segment between two consecutive coincident segments is equal to or less than a predetermined threshold value as described above, the segment information generation unit 23 determines the whole of the previous coincident segment, the subsequent coincident segment, and the discrepant segment as one event segment. The segment information D4 includes time information indicating the event segment in the video material D1. In detail, the time information indicating the event segment includes the times of the start point and the end point of the event segment or the time of the start point and the time range of the event segment.

The training data generation unit 24 generates the training data based on the video material D1 and the segment information D4. In detail, the training data generation unit 24 clips a portion corresponding to the event segment indicated by the segment information D4 from the video material D1 to make the training video. Specifically, the training data generation unit 24 clips a video from the video material D1 with respective certain ranges before and after the event segment. In this case, the training data generation unit 24 may randomly determine respective ranges to be applied before and after the event segment, or may apply ranges specified in advance. The ranges added before and after the event segment may be the same or may be different. In addition, the training data generation unit 24 sets the time information of the event segment indicated by the segment information D4 as the correct answer data. Accordingly, the training data generation unit 24 generates training data D5 which correspond to a set of the training video and the correct answer data for each event segment included in the video material D1, and outputs the training data D5 to the training unit 25.

The training unit 25 trains the event segment detection model using the training data D5 generated by the training data generation unit 24. In detail, the training unit 25 inputs the training video to the event segment detection model, compares an output of the event segment detection model with the correct answer data, and optimizes the event segment detection model based on an error. The training unit 25 trains the event segment detection model using a plurality of pieces of training data D5 generated from a plurality of video materials, and terminates the training when a predetermined termination condition is provided. The trained event unit detection model thus obtained can appropriately detect the event segment from the input video material, and output a detection result which includes time information indicating the segment, a score of an event likelihood, the tag information indicating the event name, and the like.

<Digest Generation Device>

Next, the digest generation device using the above-described trained important scene detection model and the trained event segment detection model will be described.

### First Example Embodiment

First, a digest generation device according to a first example embodiment will be described.

(Hardware Configuration)

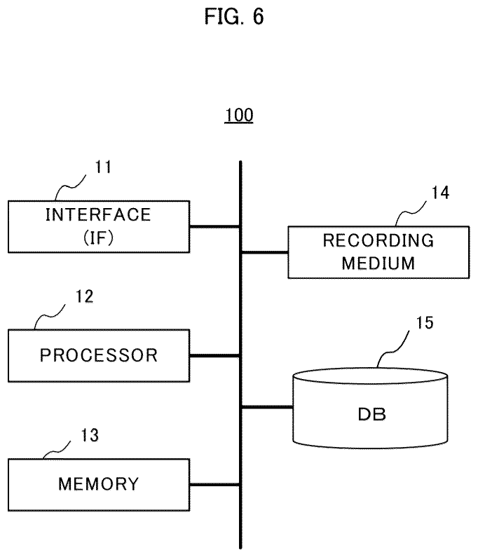

FIG. 6 is a block diagram illustrating a hardware configuration of the digest generation device 100 according to the first example embodiment. As illustrated, the digest generation device 100 includes an interface (IF) 11, a processor 12, a memory 13, a recording medium 14, and a database (DB) 15.

The IF 11 inputs and outputs data to and from an external device. In detail, the video material stored in the video material DB 2 is input to the digest generation device 100 through the IF 11. The digest video generated by the digest generation device 100 is output to the external device through the IF 11.

The processor 12 is a computer such as a CPU (Central Processing Unit, which controls the entire digest generation device 100 by executing programs prepared in advance. Specifically, the processor 12 executes a digest generation process which will be described later.

The memory 13 is formed by a ROM (Read Only Memory) and a RAM (Random Access Memory). The memory 13 is also used as a working memory during executions of various processes by the processor 12.

The recording medium 14 is a non-volatile and non-transitory recording medium such as a disk-shaped recording medium, a semiconductor memory, or the like, and is formed to be detachable to the digest generation device 100. The recording medium 14 records various programs to be executed by the processor 12. In a case where the digest generation device 100 performs various processes, the programs recorded on the recording medium 14 are loaded into the memory 13 and executed by the processor 12.

The database 15 temporarily stores the training video, existing digest videos, and the like which are input through the IF 11. The database 15 also stores information concerning the trained event segment detection model, information concerning the trained important scene detection model, a training data set used for training each model, and the like, which are used by the digest generation device 100. Note that the digest generation device 100 may include a keyboard, an input section such as a mouse, and a display section such as a liquid crystal display for a creator to instruct and input.

(How to Detect Event Segment)

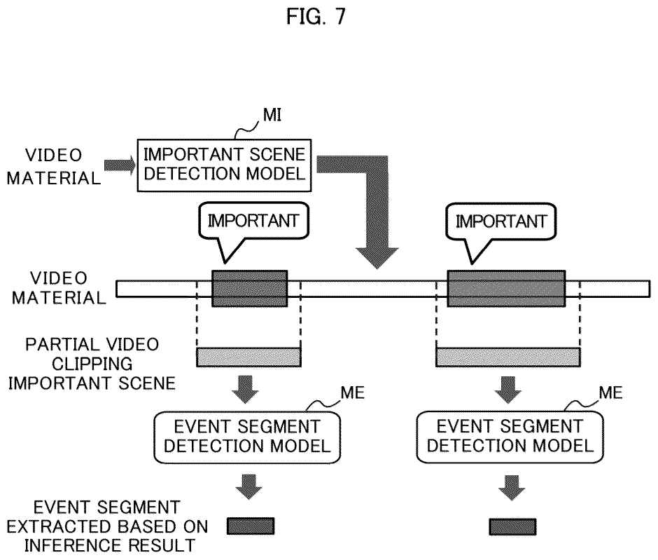

FIG. 7 schematically illustrates a detection method of the event segment by the digest generation device 100 according to the first example embodiment. In the first example embodiment, first, an important scene is detected from the video material, and a partial video including the detected important scene is input to the event segment detection model to detect an event segment.

Specifically, the video materials are input into the trained important scene detection model MI. The important scene detection model MI detects each important scene from the video material. The digest generation device 100 clips the partial video including the detected important scene from the video material, and inputs the partial video to a trained event segment detection model ME. The event segment detection model ME detects the event segment from the input partial video. In this way, since the digest generation device 100 only needs to perform an inference process for the partial video including the important scene in the video material, the inference process can be made more efficient.

(Functional Configuration)

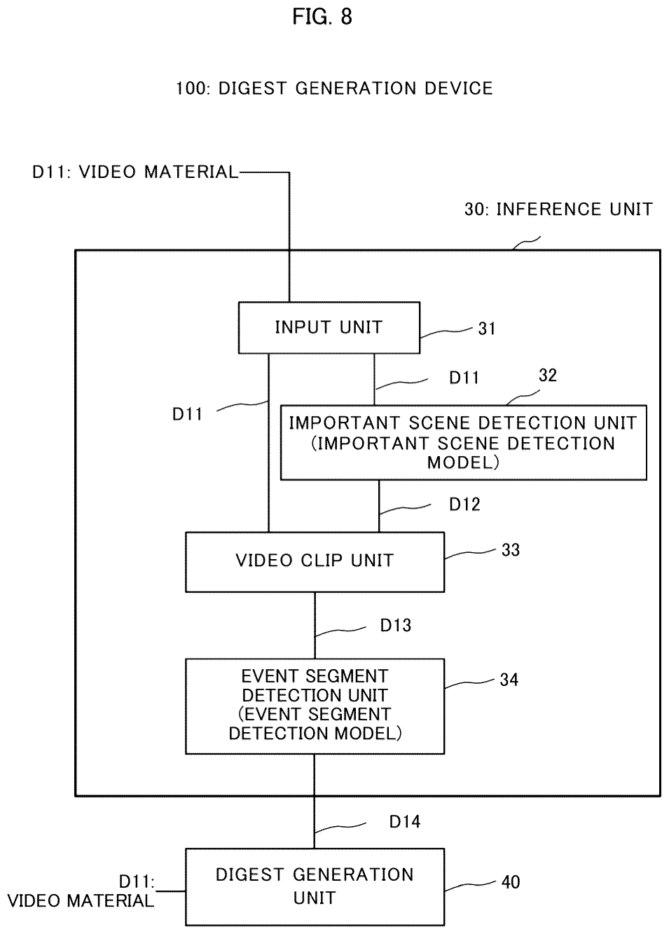

FIG. 8 is a block diagram illustrating a functional configuration of the digest generation device 100 according to the first example embodiment. The digest generation device 100 includes an inference unit 30 and a digest generation unit 40. The inference unit 30 includes an input unit 31, an important scene detection unit 32, a video clip unit 33, and an event segment detection unit 34.

The video material D11 is input to the input unit 31. The input unit 31 outputs the video material D11 to the important scene detection unit 32 and the video clip unit 33.

The important scene detection unit 32 detects the important scene from the video material D11 using the trained important scene detection model and outputs important scene information D12 to the video clip unit 33. The important scene information D12 includes, for instance, respective times of the start point and the end point of the detected important scenes.

The video clip unit 33 clips a video of a portion including the important scene from the video material D11 and outputs the clipped video as a partial video D13 to the event segment detection unit 34. As an example, the video clip unit 33 clips, as the partial video, a range where segments having a predetermined time range are respectively added before and after the important scene indicated by the important scene information D12. In this case, the time ranges to be added before and after the important scene may be different.

The video clip unit 33 may change each time range to be added before and after of the important scene according to a value of the degree of importance or a change thereof in the important scene. As described above, the important scene detection model outputs, as the important scene, a segment in which the degree of importance of the video material is equal to or more than a predetermined threshold value. Therefore, for instance, the time ranges to be added before and after may be reduced when the change in the degree of importance in the vicinity of a front end or a rear end of the important scene is abrupt, and the time ranges to be added before and after may be increased when the change in the degree of importance is gradual. Also, in a case where the change in the degree of importance is very large, an important scene may be continuing immediately after that. Therefore, in a case where the change in the degree of importance is very large, the video clip unit 33 may determine the segment of the partial video to be clipped in consideration of a presence or absence of the important scene before and after the portion to be clipped. For instance, the video clip unit 33 may determine whether there is an important scene adjacent to the front end or the rear end of the important scene when the change in the degree of importance at the front end or at the rear end of a certain important scene is greater than a predetermined value, and may clip a partial video including two important scenes when a time interval between the adjacent important scenes is equal to or less than a predetermined value.

The event segment detection unit 34 detects the event segment from the partial video D13 using the trained event segment detection model, and outputs a detection result D14 to the digest generation unit 40. The detection result D14 includes time information, scores of an event likelihood, the tag information, and the like for a plurality of event segments detected from the video material.

The video material D11 and the detection result D14 output by the inference unit 30 are input into the digest generation unit 40. The digest generation unit 40 clips each video of the event segment indicated by the detection result D14 from the video material D11, and generates the digest video by arranging the clipped videos in time series. In this manner, it is possible to generate the digest video by using the trained event segment detection model.

In the above-described configuration, the input unit 31 is an example of an acquisition means, the important scene detection unit 32 is an example of an important scene detection means, the video clip unit 33 is an example of a video clip means, the event segment detection unit 34 is an example of an event segment detection means, and the digest generation unit 4C) is an example of a digest generation means.

(Digest Generation Process)

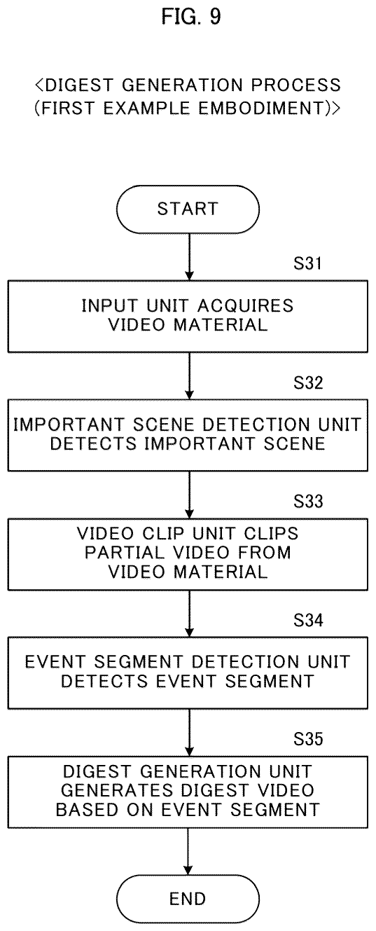

FIG. 9 is a flowchart of the digest generation process performed by the digest generation device 100 according to the first example embodiment. This digest generation process is realized by the processor 12 depicted in FIG. 6, which executes a program prepared in advance and operates as each of elements depicted in FIG. 8.

First, the input unit 31 acquires the video material D11 (step S31). The important scene detection unit 32 detects the important scene from the video material 1711, and outputs the important scene information D12 to the video clip unit 33 (step S32). Next, the video clip unit 33 clips the partial video D13 corresponding to the important scene from the video material D11 based on the important scene information D12, and outputs the partial video D13 to the event segment detection unit 34 (step S33).

Next, the event segment detection unit 34 detects the event segment from the partial video D13 using the trained event segment detection model, and outputs the detection result D14 to the digest generation unit 40 (step S34). The digest generation unit 40 generates the digest video based on the video material D11 and the detection result D14 (step S35). After that, the process is terminated.

As described above, according to the digest generation device 100 of the first example embodiment, since only the video portion including the important scene in the video material is set as a process target of the event segment detection unit 34, it is possible to improve the efficiency of the process for detecting the event segment as compared to a case of detecting the event segment from the entire video material.

### Second Example Embodiment

Next, a second example embodiment of the digest generation device will be described. Since a hardware configuration of a digest generation device 100x of the second example embodiment is the same as that of the first example embodiment illustrated in FIG. 6, the explanations thereof will be omitted.

(Detection Method of Event Segment)

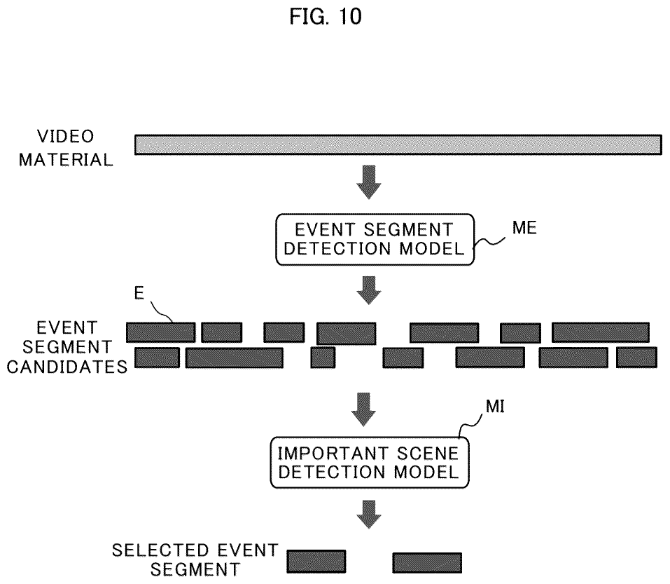

FIG. 10 schematically illustrates a detection method of the event segment by the digest generation device 100x according to the second example embodiment. In the second example embodiment, the digest generation device 100x first detects a plurality of event segment candidates E from the video material by using the trained event segment detection model ME. Next, the digest generation device 100x calculates respective degrees of importance of the acquired event segment candidates E using the important scene detection model, and selects each event segment candidate E having the degree of importance higher than a predetermined threshold as the event segment.

Specifically, the video material is input into the trained event segment detection model ME. The event segment detection model ME detects the event segment candidates E from the video material. The digest generation device 100 inputs a plurality of the detected event segment candidates E to the trained important scene detection model MI. The important scene detection model MI calculates respective degrees of importance of the input event segment candidates E, and selects, as the event segment, each event segment candidate having the degree of importance which is equal to or greater than the predetermined threshold value. Accordingly, each event segment candidate having a high degree of importance among the event segment candidates E is selected as a final event segment. Therefore, even in a scene which is detected as the event segment candidate E, the scene having the degree of importance which is not high is excluded from the digest video. In a case where the plurality of event segment candidates E are detected corresponding to the same time, the digest generation device 100x may select, as the event segment, the event segment candidate E having the highest degree of importance.

(Functional Configuration)

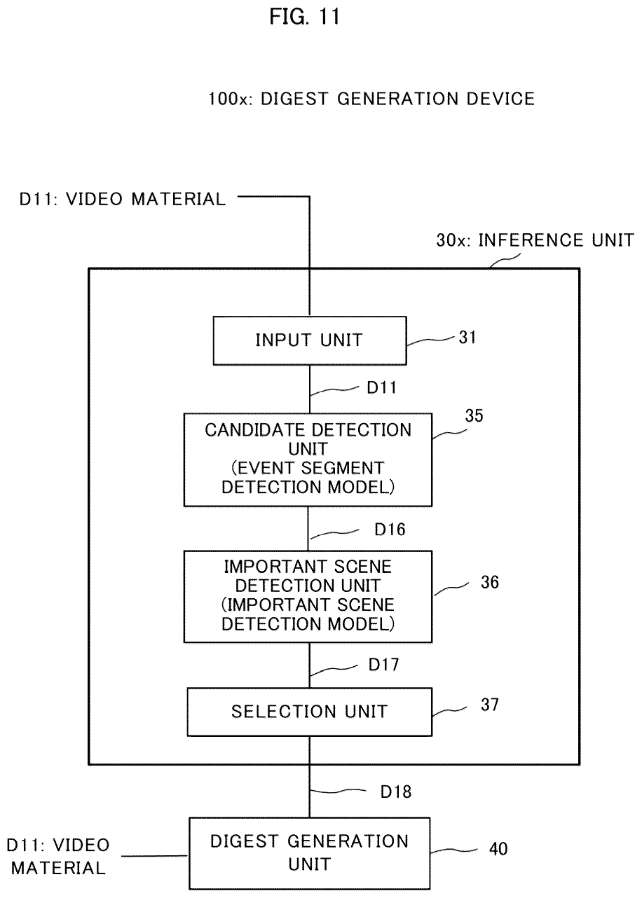

FIG. 11 is a block diagram illustrating a functional configuration of a digest generation device 100x according to the second example embodiment. The digest generation device 100x includes an inference unit 30x and a digest generation unit 40. The inference unit 30x includes the input unit 31, a candidate detection unit 35, an important scene detection unit 36, and a selection unit 37.

The video material D11 is input to the input unit 31. The input unit 31 outputs the video material D11 to the candidate detection unit 35.

The candidate detection unit 35 detects the event segment candidate E from the video material D11 using the trained event segment detection model, and outputs event segment candidate information D16 to the important scene detection unit 36. The important scene detection unit 36 calculates respective degrees of importance of the input event segment candidates E, and outputs the respective degrees of importance to the selection unit 37 as degree-of-importance information D17.

The selection unit 37 selects the event segment based on the degree of importance of each of the event segment candidates E. In detail, the selection unit 37 selects, as the event segment, the event segment candidate E having the degree of importance which is equal to or greater than the predetermined threshold value, and outputs a detection result D18 to the digest generating unit 40. The digest generation unit 40 is the same as that of the first example embodiment, and generates the digest video using the video material D11 and the detection result D18.

In the above-described configuration, the input unit 31 is an example of an acquisition means, the important scene detection unit 36 is an example of an important scene detection means, the candidate detection unit 35 and the selection unit 37 correspond to an example of an event segment detection means, and the digest generation unit 40 is an example of a digest generation means.

(Digest Generation Process)

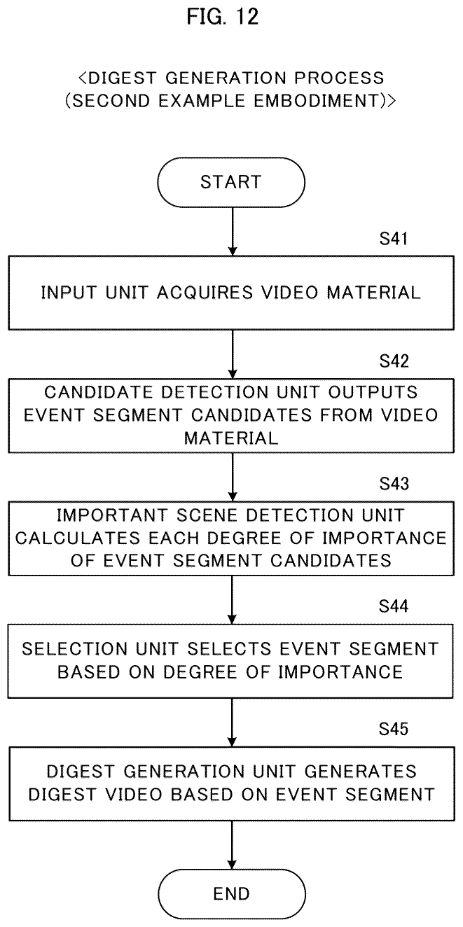

FIG. 12 is a flowchart of the digest generation process which is executed by the digest generation device 100x according to the second example embodiment. This digest generation process is realized by the processor 12 depicted in FIG. 6, which executes a program prepared in advance and operates as each of elements depicted in FIG. 11.

First, the input unit 31 acquires the video material D11 (step S41). The candidate detection unit 35 detects each event segment candidate E from the video material using the trained event segment detection model, and outputs the event segment candidate information DIE to the important scene detection unit 36 (step S42). Next, the important scene detection unit 36 calculates respective degrees of importance of the event segment candidates E, and outputs the degree-of-importance information D17 to the selection unit 37 (step S43).

The selection unit 37 selects each event segment candidate E of which the degree of importance is equal to or greater than the predetermined threshold value as the event segment, and outputs the detection result D18 to the digest generation unit (step S44). The digest generation unit 40 generates the digest video based on the video material D11 and the detection result D18 (step S45). After that, the digest generation process is terminated.

As described above, according to the digest generation device 100x of the second example embodiment, it is possible to select an appropriate event segment candidate based on the degree of importance from a plurality of event segment candidates detected from the video material and to create the digest video.

### Third Example Embodiment

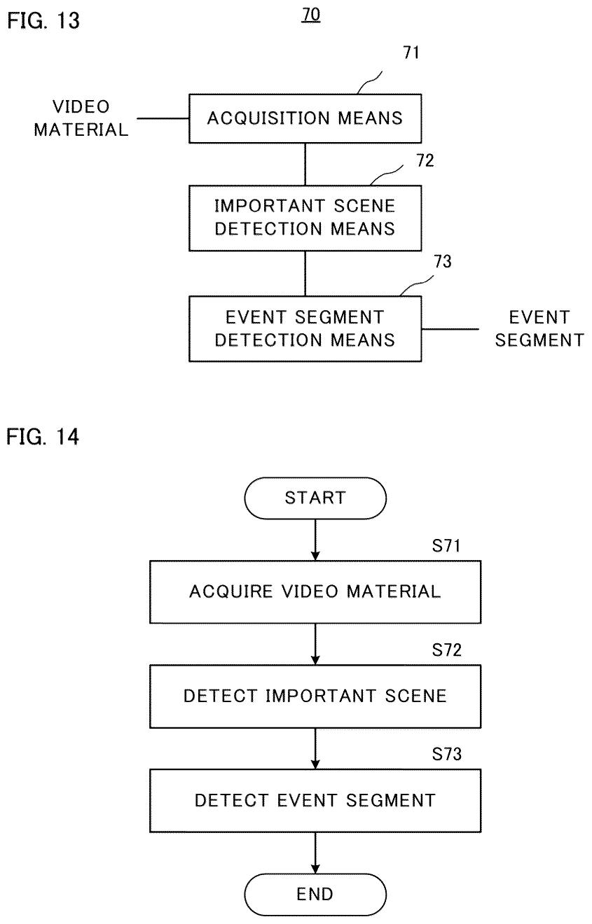

Next, an information processing device according to a third example embodiment will be described. FIG. 13 is a block diagram illustrating a functional configuration of the information processing device according to the third example embodiment. As illustrated, an information processing device 70 includes an acquisition means 71, an important scene detection means 72, and an event segment detection means 73.

FIG. 14 is a flowchart of a process performed by the information processing device 70. The acquisition means 71 acquires the video material (step S71). The important scene detection means 72 detects the important scene in the video material (step S72). The event segment detection means 73 detects the event segment in the video material using the detection result of the important scene (step S73).

A part or all of the example embodiments described above may also be described as the following supplementary notes, but not limited thereto.

(Supplementary note 1)

An information processing device comprising:
an acquisition means configured to acquire a video material;
an important scene detection means configured to detect an important scene in the video material; and
an event segment detection means configured to detect each event segment in the video material by using a detection result of the important scene.

(Supplementary Note 2)

The information processing device according to supplementary note 1, further including a video clip means configured to generate a partial video by clipping a portion including the important scene in the video material,
wherein the event segment detection means detects the event segment from the partial video.

(Supplementary Note 3)

The information processing device according to supplementary note 2, wherein the video clip means clips, as the partial video, a range where respective predetermined time ranges before and after the important scene.

(Supplementary Note 4)

The information processing device according to supplementary note 3, wherein
the important scene detection means calculates the degree of importance included in the video material; and
the video clip means changes a range to be clipped as the partial video based on a value of the degree of importance with respect to the important scene or a change of the value of the degree of importance.

(Supplementary Note 5)

The information processing device according to supplementary note 1, wherein the event segment detection means detects a plurality of event segment candidates from the video material, and selects each event segment from the plurality of event segment candidates based on a detection result of the important scene.

(Supplementary Note 6)

The information processing device according to supplementary note 5, wherein
the important scene detection means calculates respective degrees of importance with respect to the plurality of event segment candidates; and
the event segment detection means selects each event segment candidate having the degree of importance which is equal to or greater than a threshold value.

(Supplementary Note 7)

The information processing device according to supplementary note 6, wherein the event segment detection means selects an event segment candidate having the highest degree of importance when a plurality of event segment candidates corresponding to the same time are detected.

(Supplementary Note 8)

The information processing device according to any one of supplementary notes 1 to 7, further including a digest generation means configured to generate, based on the video material and event segments detected by the event segment detection means, a digest video by connecting videos of the detected event segments in a time series.

(Supplementary Note 9)

An information processing method comprising:
acquiring a video material;
detecting an important scene in the video material; and
detecting each event segment in the video material by using a detection result of the important scene.

(Supplementary Note 10)

A recording medium storing a program, the program causing a computer to perform a process comprising:
acquiring a video material;
detecting an important scene in the video material; and
detecting each event segment in the video material by using a detection result of the important scene.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

12 Processor
21, 31 Input unit
22 Video matching unit
23 Segment information generation unit
24 Training data generation unit
25 Training unit
30, 30x Inference unit
32, 36 Important scene detection unit
33 Video clip unit
34 Event segment detection unit
35 Candidate detection unit
37 Selection unit
40 Digest generation unit
100, 100x Digest generation device
200 Training device

What is claimed is:

1. An information processing device comprising:
a memory storing instructions; and
one or more processors configured to execute the instructions to:
acquire a video material;
detect an important scene in the video material; and
detect each event segment in the video material by using a detection result of the important scene.

2. The information processing device according to claim 1,
wherein the processor is further configured to generate a partial video by clipping a portion including the important scene in the video material,
wherein the processor detects the event segment from the partial video.

3. The information processing device according to claim 2, wherein the processor clips, as the partial video, a range where respective predetermined time ranges before and after the important scene.

4. The information processing device according to claim 3, wherein
the processor calculates the degree of importance included in the video material to detect the importance scene; and
the processor changes a range to be clipped as the partial video based on a value of the degree of importance with respect to the important scene or a change of the value of the degree of importance in order to generate the partial video.

5. The information processing device according to claim 1, wherein the processor detects a plurality of event segment candidates from the video material, and selects each event segment from the plurality of event segment candidates based on a detection result of the important scene.

6. The information processing device according to claim 5, wherein
the processor calculates respective degrees of importance with respect to the plurality of event segment candidates; and
the processor selects each event segment candidate having the degree of importance which is equal to or greater than a threshold value.

7. The information processing device according to claim 6, wherein the processor selects an event segment candidate having the highest degree of importance when a plurality of event segment candidates corresponding to the same time are detected.

8. The information processing device according to claim 1, wherein the processor is further configured to generate, based on the video material and event segments being detected, a digest video by connecting videos of the detected event segments in a time series.

9. An information processing method comprising:
acquiring a video material;
detecting an important scene in the video material; and
detecting each event segment in the video material by using a detection result of the important scene.

10. A non-transitory computer-readable recording medium storing a program, the program causing a computer to perform a process comprising:
acquiring a video material;
detecting an important scene in the video material; and
detecting each event segment in the video material by using a detection result of the important scene.
